(19) United States
(12) Patent Application Publication
(10) Pub. No.: US 2025/0054265 A1
(43) Pub. Date: Feb. 13, 2025

(54) SYSTEMS AND METHODS FOR OBJECT DETECTION OF UNMANNED AERIAL VEHICLES

(71) Applicant: Epirus, Inc., Torrance, CA (US)

(72) Inventors: Jiejie Zhu, Mercer Island, WA (US); Aleksandar Kojic, Seattle, WA (US)

(21) Appl. No.: 18/794,926

(22) Filed: Aug. 5, 2024

Related U.S. Application Data
(60) Provisional application No. 63/531,251, filed on Aug. 7, 2023.

(51) Int. Cl. G06V 10/25; G06T 3/40; G06T 7/11; G06V 10/44

(52) U.S. Cl. CPC G06V 10/25; G06T 3/40; G06T 7/11; G06V 10/44; G06T 2207/20081; G06T 2207/20084; G06V 2201/07

(57) ABSTRACT

A system to detect, classify and track small objects in an image frame. The system includes an image data system and image analytic system. The image data system receives real-time image data from an image capturing system and inputs the image data to image analytic system. The image analytic system performs the object detection, classification and tracking of objects in an image frame using a combination of techniques.

### CROSS-REFERENCE TO RELATED APPLICATIONS

This application claims priority to U.S. Provisional Application No. 63/531,251, filed Aug. 7, 2023, which is hereby incorporated by reference in its entirety for all purposes. Any and all applications for which a foreign or domestic priority claim is identified in the Application Data Sheet as filed with the present application are hereby incorporated by reference under 37 CFR 1.57.

### TECHNICAL FIELD

The present disclosure relates, in general, to systems and methods for detecting and tracking objects, and more particularly, to techniques for tracking objects in real time images.

### BACKGROUND

The proliferation of unmanned aerial vehicles (UAVs) presents a threat to persons, property, and national security. For example, detecting objects using computer vision has been implemented in applications like surveillance, healthcare, autonomous driving, and other image or video-based tasks. However, accurate detection of UAVs using computer vision is difficult at a distance due to the low number of pixels representing a UAV. Significant efforts have been made to enhance performance through neural networks, feature extraction techniques, and anchor-based or anchor-free approaches for efficient and meaningful data analysis and representations. However, achieving a balance between computational accuracy and robust detection across diverse conditions and object variations remains an active area of research.

### SUMMARY

The disclosure generally contemplates systems and methods for detecting, classification, and/or tracking objects represented by a small number of pixels in an image or images using Artificial Intelligence (AI).

In some aspects, the techniques described herein relate to an object detection system, including: an image capture system configured to obtain image data including at least one image frame; and a memory storing instructions that, when executed by one or more processors, cause the one or more processors to execute a network model configured to implement a Gaussian Mixture model (GMM) to detect one or more targeted objects from a plurality of potential objects in the at least one image frame, the one or more targeted objects including less than 1/100th pixels of a total number of pixels in the at least one image frame.

In some aspects, the techniques described herein relate to an object detection system, wherein execution of the instructions causes the one or more processors to divide the at least one image frame into a plurality of image tiles.

In some aspects, the techniques described herein relate to an object detection system, wherein the GMM is configured to generate a Gaussian Receptive Fields (GRFs) to dynamically adapt to diverse shapes and sizes of the one or more targeted objects in the at least one image frame.

In some aspects, the techniques described herein relate to an object detection system, wherein the network model is configured to apply one or more of the GRFs to each of the plurality of image tiles independently to capture local details and variations in the one or more targeted objects in the at least one image frame.

In some aspects, the techniques described herein relate to an object detection system, wherein execution of the instructions causes the one or more processors to detect the one or more targeted objects in each of the plurality of image tiles, the one or more targeted objects including less than a factor of each of the image tiles, the factor being 1/100th multiplied by a number of image tiles of the plurality of tiles, and wherein execution of the instructions cause the one or more processors to aggregate the plurality of images tiles for the detection of the one or more targeted objects in the at least one image frame.

In some aspects, the techniques described herein relate to an object detection system, wherein execution of the instruction cause the one or more processors to alert a user responsive to the one or more targeted objects being detected in an image tile of the plurality of image tiles.

In some aspects, the techniques described herein relate to an object detection system, wherein the network model is configured to determine an optimal number of Gaussian components for the GMM for accurate identification of the one or more targeted objects in the at least one image frame.

In some aspects, the techniques described herein relate to an object detection system, wherein execution of the instructions causes the one or more processors to identify the one or more targeted objects based comparing each the Gaussian components to a plurality of anchors.

In some aspects, the techniques described herein relate to an object detection system, wherein execution of the instructions causes the one or more processors to identify the one or more targeted objects based on a maximum likelihood estimation for each of the plurality of anchors.

In some aspects, the techniques described herein relate to an object detection system, wherein the Gaussian components are associated with at least one structure in the one or more targeted objects.

In some aspects, the techniques described herein relate to an object detection system, wherein the network model includes a neural network model configured to process the at least one image frame to determine the optimal number of the Gaussian components for each of the one or more targeted objects in the at least one image frame, the optimal number of the Gaussian components including a minimum number of the Gaussian components.

In some aspects, the techniques described herein relate to an object detection system, wherein the network model includes a modified You Only Look Once (YOLO) architecture.

In some aspects, the techniques described herein relate to an object detection system, wherein the modified YOLO architecture includes a feature pyramid network configured to upsample the image data by at least four times to capture fine-grained details of the one or more targeted objects in the at least one image frame.

In some aspects, the techniques described herein relate to an object detection system, wherein the modified YOLO architecture is configured to perform compound scaling of the image data.

In some aspects, the techniques described herein relate to an object detection system, wherein the network model includes a Convolutional Neural Network (CNN) model trained on a diverse synthetic and factual image data for tiny targeted object detection, identification, and tracking.

In some aspects, the techniques described herein relate to an object detection system, wherein execution of the instructions causes the one or more processors to determine a confidence score for the one or more targeted objects.

In some aspects, the techniques described herein relate to an object detection system, further including a display configured to display the at least one image frame, the one or more targeted objects, and features corresponding to each of the one or more targeted objects, wherein execution of the instructions causes the one or more processors to determine the features including a bounding box surrounding the one or more targeted objects and the confidence score for the one or more targeted objects.

In some aspects, the techniques described herein relate to an object detection system, wherein the one or more targeted objects change at least one of an appearance or location from a first image frame in the at least one image frame to a second image frame in the at least one image frame, and wherein the display is configured to display the at least one image frame, the one or more targeted objects in each respective image frame, and the features corresponding to each of the one or more targeted objects in a sequential order, the at least one frame including the first image frame and the second image frame.

In some aspects, the techniques described herein relate to an object detection system, wherein the one or more processors are further caused to detect the one or more targeted objects and the corresponding features in 500 milliseconds or less.

In some aspects, the techniques described herein relate to an object detection system, wherein execution of the instructions causes the one or more processors to track the one or more targeted objects across the at least one image frame.

In some aspects, the techniques described herein relate to an object detection system, wherein the plurality of potential objects includes animals, unmanned vehicles, and manned vehicles, and wherein the one or more targeted objects include the unmanned vehicles.

In some aspects, the techniques described herein relate to an object detection system, wherein each of the one or more targeted objects occupy less than 1/500th pixels than the total number of pixels in the at least one image frame.

In some aspects, the techniques described herein relate to an object detection system, further including an image capturing device configured to capture the image data, the image capturing device includes one or more cameras configured for thermal detection.

In some aspects, the techniques described herein relate to an object detection system, wherein the network model is configured to determine at least one loss function associated with the detection of the one or more targeted objects.

In some aspects, the techniques described herein relate to an object detection system, wherein execution of the instructions causes the one or more processors to determine a confidence score for the detection of the one or more targeted objects, the confidence score being associated with at least one of the at least one loss function or an image quality associated with the image data.

In some aspects, the techniques described herein relate to an object detection system, wherein execution of the instructions causes the one or processors to train the network model based on the at least one loss function.

In some aspects, the techniques described herein relate to an object detection system, wherein execution of the instructions causes the one or more processors to train the network model based on training data including the plurality of potential objects in various scenarios.

In some aspects, the techniques described herein relate to an object detection system, wherein the various scenarios includes at least one of the plurality of potential objects in at least one of a different orientation or distance.

In some aspects, the techniques described herein relate to an object detection system, wherein execution of the instructions causes the one or more processors to: detect that the one or more targeted objects is carrying a payload, and alert a user on a location of the one or more targeted objects carrying the payload.

In some aspects, the techniques described herein relate to a method 1-29.

In some aspects, the techniques described herein relate to a method for detecting an object in an image frame, the method including, by one or more processors: receiving real-time image data from an image capturing device, the real-time image data including at least one image frame; inputting the at least one image frame into a network model configured to generate a Gaussian mixture model (GMM) to detect one or more targeted objects in the at least one image frame; and by the network model, detecting the one or more targeted objects from a plurality of potential objects in the at least one image frame, the one or more targeted objects including less than 1/100th pixels of a total number of pixels in the at least one image frame.

In some aspects, the techniques described herein relate to a method, wherein the network model further includes a neural network model, the method further including, by the one or more processors, processing the at least one image frame to determine a minimum number of Gaussian components for the GMM for each of the one or more targeted objects in the at least one image frame of the real-time image data.

In some aspects, the techniques described herein relate to a method, wherein the real-time image data is received at a first time, and the one or more targeted objects in the at least one image frame are detected at a second time, the second time being 500 milliseconds or less after the first time.

In some aspects, the techniques described herein relate to a method for training an object detection system, the method including, by one or more processors: inputting training data including a plurality of potential objects in various scenarios into a network model, the plurality of potential objects including one or more targeted objects, training the network model based on the training data; inputting an image frame captured by an image-capturing device into the network model, the network model configured to generate a Gaussian mixture model (GMM) configured to detect the one or more targeted objects in the image frame, the one or more potential objects including less than 1/100th pixels of a total number of pixels in the image frame; processing at least a portion of the image frame including at least one of the one or more targeted objects with the network model to detect the one or more objects; inputting, via a user interface, a ground truth for any of the one or more targeted objects not detected by the network model; determining at least one loss function associated with each of the one or more targeted objects detected; and re-training the network model based on the at least one loss function.

In some aspects, the techniques described herein relate to a method, wherein the at least one loss function includes at least one of class loss, box loss, or objectness loss.

In some aspects, the techniques described herein relate to a method, further including, by the one or more processors, determining a confidence score for the detection of the one or more targeted objects, the confidence score being associated with at least one of the at least one loss function or an image quality associated with the image data.

In some aspects, the techniques described herein relate to a method, wherein the training data includes a plurality of object images, each of the plurality of object images including a representation of one of the plurality of potential objects in a particular scenario of the various scenarios.

In some aspects, the techniques described herein relate to a method, wherein the particular scenario includes at least one of a particular orientation, a particular lighting, or a particular distance, a first object image of the plurality of images includes a particular object of the plurality of potential objects in a first particular scenario, a second object image of the plurality of images includes the same particular object in a second particular scenario, and wherein the first particular scenario is different from the second particular scenario.

In some aspects, the techniques described herein relate to a method, wherein the plurality of potential objects further includes a type of object, the type of object including the one or more targeted objects and at least one non-targeted object, and each of the plurality of object images includes a label associated with the object represented in corresponding object image, the label including the type of object and the particular scenario of the object, and wherein the network model is trained by processing each of the objects and the corresponding label in each of the plurality of object images.

In some aspects, the techniques described herein relate to a method, further including, by the network model, determining an optimal number of Gaussian components for the GMM for accurate identification of the one or more targeted objects in the image frame.

In some aspects, the techniques described herein relate to a method, wherein the Gaussian components are associated with at least one structure in the one or more targeted objects.

In some aspects, the techniques described herein relate to a method, wherein the network model includes a neural network model, and wherein the method further includes, by the neural network model, processing the image frame to determine the optimal number of Gaussian components for each of the one or more targeted objects in the image frame.

In some aspects, the techniques described herein relate to a method, further including, by the re-trained network model, adjusting the optimal number of Gaussian components for each of the one or more targeted objects in the image frame in order to at least one of: increase an accuracy for identification of the one or more targeted objects, or reducing processing requirements for the network model.

In some aspects, the techniques described herein relate to a method, further including, by the network model, identifying the one or more targeted objects based comparing each the Gaussian components to a plurality of anchors.

In some aspects, the techniques described herein relate to a method, further including, by the network model, identifying the one or more targeted objects based on a maximum likelihood estimation for each of the plurality of anchors.

In some aspects, the techniques described herein relate to a method, further including, by the one or more processors, dividing the image frame into a plurality of image tiles.

In some aspects, the techniques described herein relate to a method, further including, by the GMM model, generating a Gaussian Receptive Fields (GRFs) to dynamically adapt to diverse shapes and sizes of the one or more targeted objects in the image frame.

In some aspects, the techniques described herein relate to a method, further including, by the network model, applying one or more of the GRFs to each of the plurality of image tiles independently to capture local details and variations in the one or more targeted objects in the image frame.

In some aspects, the techniques described herein relate to a method, further including, by the network model, detecting the one or more targeted objects in each of the plurality of image tiles, the one or more targeted objects including less than a factor of each of the image tiles, the factor being 1/100th multiplied by a number of image tiles of the plurality of tiles, and, by the one or more processors, aggregating the plurality of images tiles for the detection of the one or more targeted objects in the image frame.

In some aspects, the techniques described herein relate to a method, wherein the network model includes a modified You Only Look Once (YOLO) architecture.

In some aspects, the techniques described herein relate to a method, wherein the modified YOLO architecture includes a feature pyramid network, and the method further includes, by the feature pyramid, upsampling the image frame by four times to capture fine-grained details of the one or more targeted objects in the image frame.

In some aspects, the techniques described herein relate to a method, further including, by the modified YOLO architecture, compound scaling the image frame.

In some aspects, the techniques described herein relate to a method, wherein the network model includes a Convolutional Neural Network (CNN) model trained by the training data, and the training data includes diverse synthetic and factual image data for tiny targeted object detection and identification.

In some aspects, the techniques described herein relate to a method, further including, by the one or more processors, determining a confidence score for the one or more targeted objects.

In some aspects, the techniques described herein relate to a method, further including, by the one or more processors, determining features including a bounding box surrounding the one or more targeted objects and the confidence score for the one or more targeted objects, and, by a display, displaying the image frame, the one or more targeted objects, and the features corresponding to each of the one or more targeted objects.

In some aspects, the techniques described herein relate to a method, further including, by the display, displaying the image frame and then a second image frame captured sequentially after the image frame by the image-capturing device, the one or more targeted objects in each respective image frame, and the features corresponding to each of the one or more targeted objects, wherein the one or more targeted objects change at least one of an appearance or location from the image frame to the second image frame.

In some aspects, the techniques described herein relate to a method, further including, by the one or more processors, detecting the one or more targeted objects and the corresponding features in 500 milliseconds or less.

In some aspects, the techniques described herein relate to a method, wherein the plurality of potential objects includes animals, unmanned vehicles, and manned vehicles, and wherein the one or more targeted objects include the unmanned vehicles.

In some aspects, the techniques described herein relate to a method, wherein each of the one or more targeted objects includes less than 1/500th pixels than the total number of pixels in the image frame.

In some aspects, the techniques described herein relate to a method, further including, by the network model, detecting if the one or more targeted objects is carrying a payload, and in response to detecting that the one or more targeted objects is carrying the payload, by a display, displaying a location of the one or more targeted objects carrying the payload.

The systems, methods, techniques, modules, and devices of this disclosure each have several innovative aspects, no single one of which is solely responsible for the desirable attributes disclosed herein.

### BRIEF DESCRIPTION OF THE FIGURES

The disclosure is more fully appreciated in connection with the following detailed description taken in conjunction with the accompanying drawings, in which:

FIG. 1 illustrates a block diagram of an example of a target object detection system according to one or more aspects.

FIG. 2 illustrates computing environment in which a target object detection system is implemented according to one or more aspects.

FIG. 3 illustrates a neural network architecture implemented in an image processing system according to one or more aspects.

FIGS. 4(a), 4(b), and 4(c) illustrate examples of objects imaged at various distances by the target object detection system according to one or more aspects.

FIGS. 5(a) and 5(b) illustrate processes implemented by a neural network model of the image processing system.

FIGS. 6(a) and 6(b) illustrates examples of an output of a target object detection system.

FIG. 7 illustrates a method of target object detection, classification, and tracking.

FIG. 8 illustrates a computing environment in which a neural network detects and classifies a target object imaged according to one or more aspects.

Like reference numerals refer to corresponding parts throughout the several views of the drawings.

### DETAILED DESCRIPTION

The present disclosure introduces methods and systems for advanced object detection and tracking in real time, such as using a real time image or video frame, and in a real-world environment. In some instances, the detection and tracking of an object can occur within about 300-400 milliseconds of capturing an image of the object, so that two or three frame assessments can be completed per second. Thus, the detection, tracking, and assignment of relevant features for the targeted object can be completed, for example, in less than 500 milliseconds. The amount of time can be less depending on the size of the image and the values referred to are intended to be exemplary. For instance, in some images, a frame can be processed and detection, tracking, and assignment can be completed in less than 1 second, 900 milliseconds, 800 milliseconds, 700 milliseconds, 650 milliseconds, 350 milliseconds, 200 milliseconds, 50 milliseconds, etc. More particularly, the present disclosure introduces features for detection, classification, and/or tracking of tiny objects (e.g., UAVs) within a field of view of one or more cameras, such as by implementing a Deep Learning Neural Network architecture trained to generate Gaussian Mixture Models (GMMs) based on high-resolution image data. These tiny objects (or small objects) can be typically far away from the image-capturing device and therefore can be minuscule in comparison to the total image size (such as, but not limited to, being 1/50^{th}, 1/100^{th}, 1/150^{th}, 1/200^{th}, 1/300^{th}, 1/500^{th}, 1/750^{th}, 1/1000^{th}, etc. of the total image size). Even when being captured by a high-definition camera, such tiny objects may be on the order of only 350 pixels, 250 pixels, 100 pixels, 90 pixels, 80 pixels, 65 pixels, 50 pixels, 35 pixels, 15 pixels, 5 pixels, 1 pixel, etc. in size. These values are merely exemplary and are not intended to be limiting.

Waiting until the target object is closer to the image capturing device would help increase the number of pixels representing the object; however, this may be inadvisable if the target object is a UAV carrying a payload (which may be dangerous) or a reconnaissance UAV, or another dangerous object. Accordingly, detecting the object when it is that close may reduce the ability to successfully implement defensive measures. As a result, the object may need to be captured for detection as far as possible, such as, but not limited to, within 4000, 2000 meters, 1500 meters, 1000 meters, 800 meters, 750 meters, 500 meters, 200 meters, etc., and concurrently captured to track its movement. The Deep Learning Neural Network (DNN), in some aspects, includes features of a Convolutional Neural Network (CNN) and may be configured to detect tiny (or small) objects at an extended distance through innovative design enhancements. Small objects can be difficult to detect due to the low number of pixels with which they can be represented due to the distance they can be captured at. Furthermore, small objects can be difficult to identify as an object of interest, as the low number of pixels may appear similar to many other potential objects, such as flying animals and manned vehicles.

According to the present disclosure, a Neural Network implementing a GMM enables the construction of a mixed Gaussian Receptive Field (GRFs) that can be adapted to different shapes of objects imaged to identify whether an object is an object of interest for targeting. GMMs described herein can involve Gaussian Receptive Field mixtures applicable to the identification of various object shapes, for example, UAVs or other flying objects of interest, at a distance. Furthermore, a GMM can modify the weight of each location to gradually change in given directions, such as gradually decreasing from the center towards the periphery. A typical single Gaussian model has difficulty with detecting and identifying small objects because the relatively small number of pixels representing the object results in low-quality images of the objects, which makes it difficult to distinguish what the particular object is. For example, the single Gaussian model can fixate on the center of the image and may have difficulty distinguishing whether the object is a UAV or a flying animal, such as a bird, which could otherwise be distinguished by the peripheral features of the object, such as a UAV's rotors compared to the wings of a bird. The proposed GMM includes additional receptive fields that can focus on the peripheral features of a target object to better identify whether the target object (e.g. an unmanned vehicle, such as a drone) is actually the target object rather than one of many potential objects (e.g., animals, such as birds, or manned vehicles, such as planes, etc.).

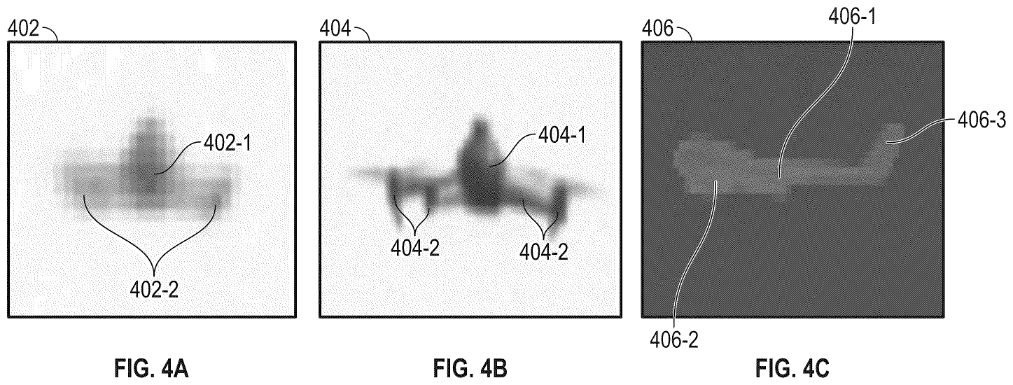

The foregoing features can facilitate the modeling of the geometric relationship between any detection and/or tracking point in relation to the actual moving target. Various aspects of the present disclosure include training of a You-Only-Look-Once (YOLO) architecture for generating GMMs in real-time configured to register objects represented by a small number of pixels in image data. The use of a neural network, such as the YOLO architecture, can provide the optimal number of Gaussian fields to use for accurately determining whether an object is a target object. In some instances, the optimal number of Gaussian fields is the minimum number required to accurately identify whether an object is a target object. Although higher numbers of Gaussian fields can increase the number of peripheral features to analyze and more accurately identify the object as a target object or not from the potential objects, it also increases the processing requirements of a system, which can reduce the speed that frames can be analyzed and provided to the user. In some cases, processing speed can be reduced such that a UAV carrying a payload may not be identified and notified to the user before it is too late to take defensive or preventative actions. Furthermore, increasing the number of Gaussian fields may be redundant for a particular object because the image quality, such as for objects with a low number of pixels, may only depict relatively few features. For example, for a UAV captured at 800 meters away from an image capturing device, such as shown in FIG. 4(a), the image may not include fine details such as the rotor blades but could include enough detail to analyze the rotors. Therefore, the number of Gaussian fields to accurately depict the UAV can be dependent on the image quality, as additional Gaussian fields would not capture the blurry features in any case but would still cause increased processing requirements.

Various features disclosed herein alleviate receptive field mismatches associated with detecting and/or tracking objects represented by a small number of pixels in one or more image frames. Moreover, the proposed systems and methods provide tracking statistics or label assignments using Max Intersection of Union (IOU) or Adaptive Training Sample Selection (ATSS) process(es) for small objects with limited bounding box information. The disclosure herein provides an approach balancing positive and negative samples representing small objects in the one or more image frames, thereby improving training of one or more AI models. In some aspects, the disclosure provides a method and system to integrate AI with Gaussian Mixture Models for real-time object detection, classification, and tracking of objects in image data to achieve increased levels of accuracy.

The AI models can be trained, in at least some implementations, to detect, classify, and/or track such objects having various shapes and/or sizes. The disclosed AI models may be continually or repeatedly trained to construct a mixture of image (or Gaussian) receptive fields, also known as Gaussian receptive fields, which can dynamically adapt to the characteristics of any tiny object in terms of shape and size within the image frame. Additionally, the trained AI models disclosed herein can adjust to accommodate relationships between detected points based on the specific sizes and shapes of the objects.

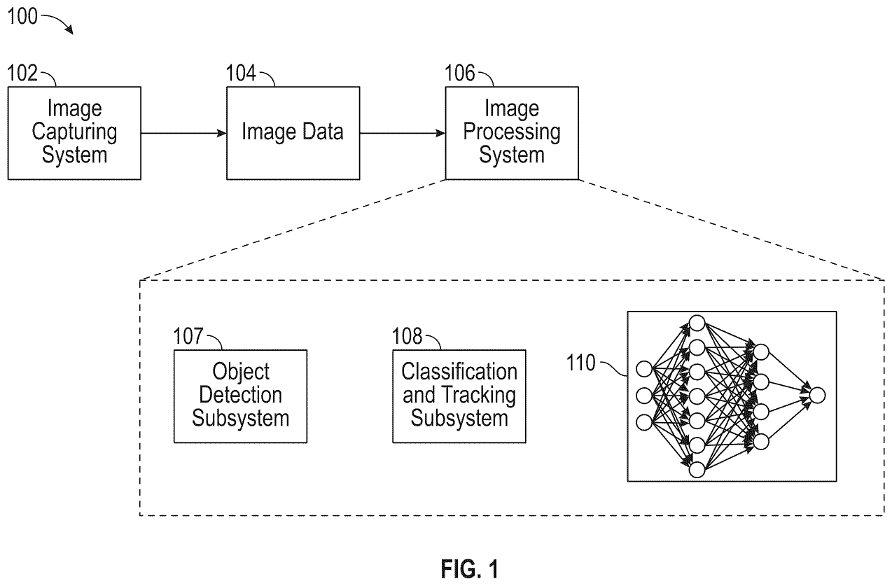

FIG. 1 shows a block diagram illustrating an example of an object detection system 100. The system 100 comprises an image capturing system 102 configured to generate image data 104, an image processing system 106, and an image classification and tracking subsystem 108. Any one or more of the image processing system 106 or image classification and tracking subsystem 108 may include one or more processors or electronic processing systems.

The image capturing system 102 can be a collection of one or more imaging devices (e.g., a video camera, a phone camera, internet protocol (IP) camera, surveillance camera) configured to generate image data 104 generated based on input to one or more imaging sensors (e.g., charge-coupled device sensors, complementary metal oxide semiconductor sensors). In some instances, the image capturing system 102 can include thermal detection, such as an Electro-Optical (ER) or Infra-Red (IF) system, to detect objects during non-optimal lighting conditions. Similarly, the image capturing system 102 can include radar to detect hidden or discrete objects. In some instances, more than one image capturing system 102 can be used to supplement each other, such as a high resolution system supplementing the quality image of a thermal detection system with lower resolution. A data storage system (not shown) may receive and store the image data 104 from image capturing system 102. The data storage system may include volatile and/or non-volatile data storage (e.g., Read Only Memory (ROM), Random Access Memory (RAM),flash memory, solid state memory). The data storage may reside internally in the image capturing system 102 or coupled to the image capturing system 102.

The image data 104 can be processed by an image processing system 106. The image processing system 106 includes an object detection subsystem 107 that detects the presence of objects (e.g., drone or unmanned vehicle or flying animals or manned aerial vehicles, etc.) or other features within an image frame. The image processing system 106 includes a classification and tracking subsystem 108. As a result of detecting the presence of an object of interest within an image frame, the image classification and tracking subsystem 108 may be configured to classify aspects of the detected object (e.g., type of the object, position of object, confidence score or blob information, or payload information, etc.) and/or track the position of the object(s) relative to the detected position of the object in sets of previously-captured image data.

In various aspects, the system 100 implements artificial intelligence, such as a neural network (NN) model 110 to detect, identify, classify and/or track the object(s) in one or more image frames. In various implementations, the NN model 110 can be specifically trained for detection and tracking of objects represented by a small number of pixels in diverse image sets. The NN model 110 may be trained using image data to adapt the efficient and effective object detections and tracking techniques to the real-world scenarios. The NN model 110 can be configured to be integrated into computer or processing systems equipped with memory and processing capabilities.

The proposed neural network architecture, in some implementations, utilizes a convolutional neural network (CNN), such as a unique You Only Look Once (YOLO) base architecture, that enables efficient object detection and tracking to allow it to identify and classify objects of varying shapes and sizes with exceptional accuracy. The YOLO architecture can be specifically trained to generate and cluster Gaussian distributions according to GMM principles based on the tiny objects in image data. In various implementations, the proposed model may be continuously trained by updating its network weights with real-time data so that the model dynamically adapts to changes in environmental conditions.

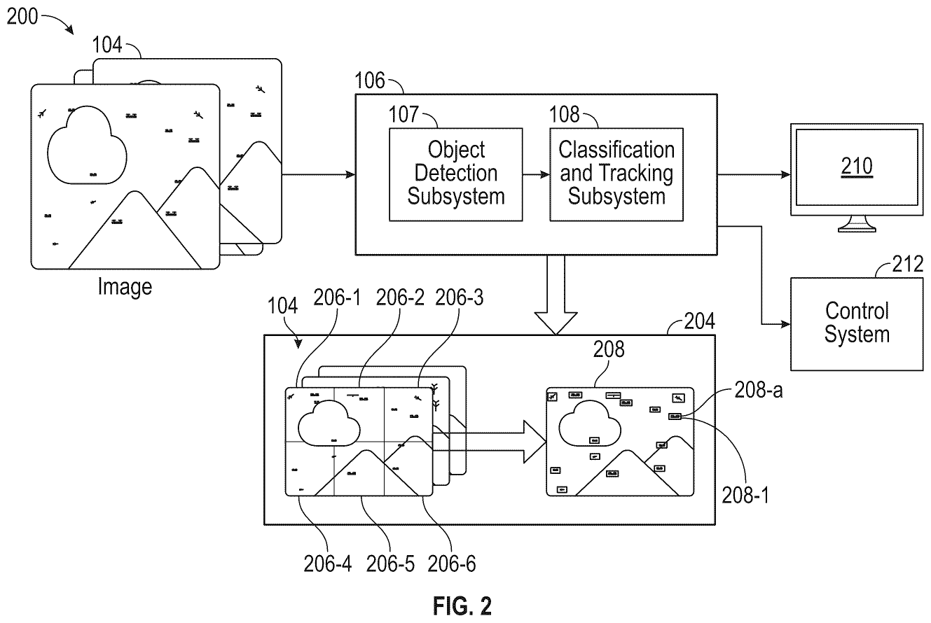

In various implementations, details of the system 100 are further explained with respect to FIGS. 2-5 of the drawings.

FIG. 2 shows an environment 200 in which image data (e.g., image frames) can be analyzed and the object information can be displayed according to one or more aspects.

Image data 104 comprising a set of image frames that can be fed into the image processing system 106. The image processing system 106 detects the presence of various objects within an image frame using the object detection subsystem 107 and, as a result of detection, thereafter, classifies and tracks the object(s) of interest using image classification and tracking subsystem 108. The image processing system 106 may include one or more processors or electronic processing systems configured to perform operations using artificial intelligence models, as described herein.

The image processing system 106 may be a computer system or electronic processing system embodied as software, hardware components, or a combination thereof. The image processing system 106 further includes memory in the form of computer readable medium such as random-access memory (RAM), read only memory (ROM), disk, flash memory, solid state memory, etc., that stores a set of reference images and training data. The image processing system 106 may be trained using training data on deep learning models or neural network models for object detection, classification, and/or tracking.

In FIG. 2, image data 104 comprising the set of image frames can be extracted within a computing environment 204 of the image processing system 106 from a real-time video. Individual frames can be sequentially processed by the processing system 106. In some instances, every other frame is processed by the processing system 106, or in some instances every 10^{th} frames, or in some instances every 20^{th} frame. The selection for frame rate selection can be determined as needed, and the examples provided herein are not intended to be limiting. Image processing system 106 uses one or more software algorithms or software programs to perform the division of each image frame into various tiles or grids (e.g., 206-1, 206-2, 206-3, 206-4. 206-5, 206-6), and identifies region of interest(s) in each tile of the image frames. A region of interest (ROI) can be an area that contains an object in an image frame (or in each tile). For example, the ROIs in a tile may include flying objects, UAVs, birds, or other objects that can be distinguishable from a background or environment.

The NN model 110 extracts the ROIs from each tile and evaluates whether each ROI contains a target object, such as a fixed-wing UAV or a multi-rotor UAV, using a GMM technique. The NN model 110 can be trained to generate a set of Gaussian distributions for pixel data of the object in each ROI. The NN model 110 can be further trained to determine whether the set of Gaussian distributions generated represents a target object. For instance, the NN model 110 may determine that the set of Gaussian distributions generated can be similar to or corresponds to a GMM presented to the NN model 110 during training. As a result of determining that the set of Gaussian distributions represents a target object, the NN model 110 may generate various outputs associated with the ROI and/or the pixel data.

In various implementations, GMM performs the extraction process, for example, background extraction and foreground extraction of each object in each tile. A GMM model can include density function, weight factor, probability distribution, mean and variance functions, a combination of these functions can be applied to the background and foreground pixel data of each tile of the image frame. The pixel data from the image data 104 can be modeled in Gaussian distribution and can be compared with the background and foreground pixel data of each image frame. A GMM candidate model can be formed based on the compared pixel data. For example, background and foreground can be determined in each tile based on the standard deviation and weight factors, and a GMM candidate model can be categorized. In various implementations, background and foreground data can be categorized in binary values (e.g., 0 and 1) in the GMM. The identified foreground data can be further processed, for example by using a filtration function or function of the NN model 110, or software by the processing system 106, to detect the presence of an object in the foreground. In various implementations, various morphological processes or filtering operations can be performed to isolate pixel data representing the target object in a blob area in the image frame. For example, with respect to FIG. 2, a processed image frame 208 shows a target object 208-a detected surrounded by a bounding box 208-1.

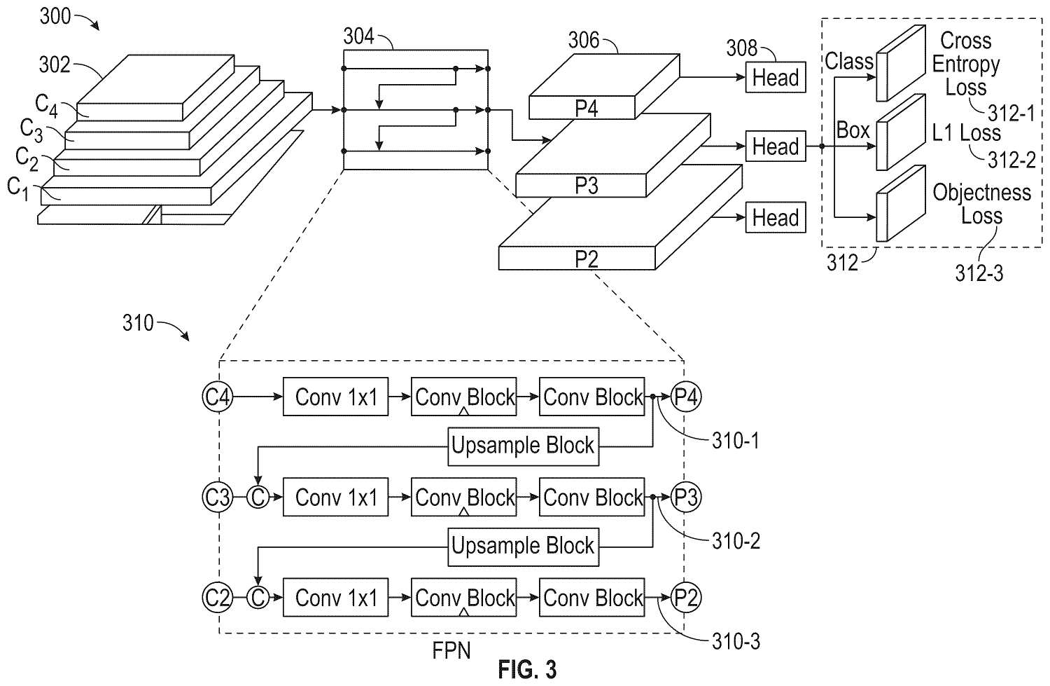

After the object is detected in the blob area, the process of object classification and tracking can be performed by the classification and tracking subsystem 108. The image classification and tracking subsystem 108 applies image object localization, machine learning, and/or deep learning techniques (e.g., convolutional neural network) to classify the object and provide tracking information of the object. The classification information may include, for example, the type of object, name of the object, size of object, the shape of the object, technical features, any payload, or to the object, Similarly, the tracking information may include the position of the object, the direction of the object, altitude of an object, etc. In some implementations, deep learning techniques can rely on You Only Look Once (YOLO) architecture to classify various features of objects and provide tracking information. Various details of how YOLO architecture can be used in deep learning techniques for object classification and tracking is further explained in FIGS. 3 to 6.

In various implementations, the image processing system 106 can implement a GMM technique, a YOLO architecture, intelligent motion detecting software (or program), and various other training models to perform target object recognition, create a bounding box (or blob) around the detected target object, provide a confidence score of the object, and various other feature data of the object in the real time image frames. The bounding box can be a region highlighted as square shaped or rectangular shape or circular shape marking around the detected object, and in some instances, be colored, such as to differentiate from detected objects and ground truths. In various implementations, the bounding box can be presented with the tracking information.

The image processing system 106 outputs results of the image processing of the image frame(s) to one or more devices and/or systems, such as a computing device 210 and/or a control system 212 (which may include one or more processors or electronic processing systems). The computing device 210 may be a desktop computer, a laptop or notebook or tablet computer or digital media player or any other suitable electronic device. The computing device 210, based on the output received from the image processing system 106, displays various information of the detected object and tracking information of the object in an image frame, for example, the display screen of the computing device 210 can display detected object surrounded by the bounding box, name of the object, type of the target object, shape of the target object, color of the target object, a status indicating any payload attached to the target object, brand of the target object, speed of the target object, altitude of the target object, direction of the target object, or other technical data associated with the target object in the image frame(s). In some instances, an alert system (which may include one or more processors or electronic processing systems) may notify or alert a user if a detected object is determined to be carrying a payload. In such instances, the alert may be presenting the detected object on a user interface (such as, a display), changing an indicator color or value on the bounding box for the detected object, prompting a message on the user interface, prompting a noise or vibration to the user, and/or any combination thereof. In some instances, an alert system may present an alert or notification to the user if any targeted object of interest is detected, and may indicate which section (or tile) of the image frame the detected object is located in. Additionally, the user can be notified by a sound, vibration, alert, and/or combination thereof. In various implementations, the bounding box that includes the detected object also shows values of the object, such as confidence score, altitude, and directional details of the object, etc. In some implementations, the image processing system 106 can be configured to output video data including the image data 104 with bounding boxes around the detected target objects. In some implementations, the image processing system 106 can be configured to output video data that includes a confidence score associated with each bounding box and/or other technical data described herein.

FIG. 3 shows a training process of a NN model of an image processing system according to one or more aspects. More particularly, FIG. 3 illustrates an architecture 300 of the NN model 110 that can be trained to perform target object detection, classification, and tracking processes of the image processing system 106. In some instances, the NN model 110 undergoes supervised training to alleviate false positives by providing label assignments to ground truths. The proposed architecture 300 described in FIG. 3 is a YOLO architecture classified mainly into: YOLO backbone (e.g., 302), YOLO neck (e.g., 304, 306, 310), YOLO head (e.g., 308) and YOLO loss 312. The YOLO backbone can be a convolutional neural network that pools image pixels to form features at different resolutions. The YOLO backbone can be pretrained on a classification dataset, such as ImageNet, in order to reduce the size of the input data while maintaining relevant features. The YOLO Neck can combine and mix the varying representations resolution output by the YOLO backbone. The YOLO Head can make the bounding box and class prediction based on the mixed representations. During YOLO loss, the predictions and classifications can be scrutinized using three loss functions, such as for class, box, and objectness.

The architecture 300 takes an image as input at 302 and employs a deep convolutional neural network model to detect the object in the image. To begin the process, the input image frame can be divided into various grid cells (e.g., tiles) or equal shapes for example, into N×N grid cells, where N is a numeric value of any number of grid cells. For instance, the input image frame can be divided into tiles (or grid) of 2×2, 3×3, 4×4, . . . , N×N. Each tile (or grid) can be then compressed or downsampled to create a dataset. The compressed dataset of each tile of each image frame is shown as C1, C2, C3, and C4 in 302. In various implementations, a combination of image frame and tile of the image frame can be fed together as an input to the training model at 302. A network model, such as a neural network or Convolutional Neural Network (CNN), can be established that pools image pixels to form features at different resolutions. The network model can employ a pretrained model trained on synthetic data (or simulated data) and real-world factual data (e.g., actual field data) that includes a mixture of image data. Simulated data can include digitally created data, such as hyper realistic images created by graphics engines. The image data can include both targeted objects (e.g., unmanned vehicles, etc.) and non-targeted objects (e.g., animals or manned vehicles, etc.) in various scenarios. For example, image data can be a depiction of the objects in various scenarios, including but not limited to blurred images, image data from various lighting conditions, actual field data, images of various objects in numerous shapes and sizes, images of various objects in different orientations or distances, etc. Each of the images in the image data can be labeled with the particular type of object (e.g., rotor drones, wing drones, birds, airplanes, etc.) represented in the image, and in some instances, can include scenarios associated with the object in the image. The model can be trained with this image data, and corresponding labels, to be able to distinguish between different objects in a variety of different scenarios.

The backbone 302 processes each tile and image frame sequentially in the convolutional layers of the CNN model. The CNN model extracts feature representations from different resolutions of the input image. The input tiles and image frames undergo a series of convolutions and pooling operations in the convolutional layer and filters to analyze image, by detecting edges, textures, and visual patterns of the object. The feature extraction capability allows the model to capture essential details and patterns from the image, making it ideal for object detection.

In various implementations, the input image frame can be divided into multiple tiles and the GMM can be applied on each tile independently. Whereas, in various other implementations, GMM can be applied to each tile of the image frame and the image frame itself. The GMM captures local details and variations in the appearance of tiny objects within each tile. This can help to reduce the ratio of pixels from the tiny object versus the size of a smaller image tile as compared to the size of the larger image frame. As described herein, these tiny objects can be typically far away from the image-capturing device and therefore can be minuscule in comparison to the total image size (such as, but not limited to, being 1/50^{th}, 1/100^{th}, 1/150^{th}, 1/200^{th}, 1/300^{th}, 1/500^{th}, 1/750^{th}, 1/1000^{th}, etc. of the total image size) so that even after having been captured by a high definition camera, may be in the order of only 350 pixels, 250 pixels, 100 pixels, 90 pixels, 80 pixels, 65 pixels, 50 pixels, 35 pixels, 15 pixels, 5 pixels, 1 pixel, etc. These values are merely exemplary and are not intended to be limiting. By processing image tiles instead of the total image frame, the ratio is increased by a factor according to the number of tiles. For example, where an object is 1/120^{th} the size of a total image frame and the image frame is subdivided as a 4×3 grid into 12 tiles, the object compared to each tile will only be 1/10^{th} of the processed size of the image tile. Thus, the processing requirements to differentiate from the background can be reduced, as explained below.

The GMM builds a mixture of Gaussian receptive fields for each tile, which can adapt dynamically to tiny objects of different shapes and sizes. In other words, by applying GMM on individual tiles, the model can localize its analysis, enabling fine-grained examination of the image content and efficient detection of tiny objects. In various implementations, GMM can be trained to detect the false and missed detections in each image frame. The false detection can be an area where there may be no object that can be present or there may not be enough foreground data of the object to be determined as an object. Whereas the missed detection can be where one or more objects are present and were not detected by the model. The GMM can be augmented, and the overall training process can be improved by updating the missed and false detection data to the neural network model.

A segmentation process can be thereafter incorporated into the object detection process to optimize the representation of objects in each tile. The segmentation process may involve dividing the image into meaningful regions based on visual similarities. The segmentation approach helps to determine the optimal number of Gaussian components to accurately represent objects within each tile. The GMM calculates the mean variance and weights of these receptive fields. In various implementations, the GMM models each pixel in each tile as a mixture of Gaussians and uses learning algorithms or trained data to update the model. In various implementations, a background and foreground subtraction of pixels can be adopted by the GMM to determine the local changes of pixel data in each tile of the image frame. As such, by applying one or combination of above approaches the GMM effectively models the appearance and variations of tiny objects, such as drones within each tile.

After the GMM application, feature data can be created for each detected object in each tile of the image frame. More particularly, feature pyramid network (FPN) can be created in process 304 that extracts features of each dimension and upsamples the feature data using upsampling techniques in process 310. In various implementations, a feature pyramid network 304 can be created by taking the feature maps generated at different layers of CNN and aggregating them to form a pyramid of feature map. The feature pyramid networks include multiple levels of resolution, and each level corresponds to different spatial resolutions.

In order to create the features of detected object in each tile of the image frame to form the feature pyramid 306, an upsampling technique can be implemented under 310. The upsampling technique can be helpful to handle the tiny objects more effectively. In 310, the data can be magnified for each detected object of each tile of the image frame. In FIG. 3, input 310 shows the upsampling process of image data whereas, output 310-1, 310-2, 310-3 shows the upsampling process of each detected object of each tile of each image frame. As such, the magnification of data in the upsampling step in 310 focuses on each tile containing the tiny object. The upsampling process enables the CNN model to capture intricate details and reduce the latency during object classification.

The upsampled image data of each detected object in each tile undergoes a series of convolutions and pooling operations in the convolutional layers to identify visual features and pattern of object from the tile. The top-down pathway technique shown as 310-1, 310-2, 310-3 can be responsible for upsampling the lower-level feature maps to match the size of higher-level feature maps. For example, the lower-resolution feature maps can be expanded to match the dimensions of the higher-resolution feature map so that the network captures finer details and features from lower layers while maintaining spatial information from higher layers.

After the upsampling process, the aggregated feature maps from process 304 forms feature pyramid 306. Feature pyramid 306 includes feature maps of objects at multiple scales and different spatial resolutions. The multi-scale feature representation enables the YOLO model to detect objects of various sizes and scales effectively.

The feature maps from feature pyramid 306 can be fed into head 308. The head 308 can be responsible for making the object predictions, including bounding boxes, class probabilities (or classifications). In various implementations, the feature maps from the feature pyramid 306 contains rich contextual information that helps head 308 to perform object detections, creating bounding boxes around the detected objects, track the object, and perform classification of objects across different scales. In various implementations, the bounding box can be labeled with confidence scores (or ground truth values) and other tracking details. The bounding box can be a precise outline that shows the object and object's location in an image frame whereas, the confidence score to the bounding box indicates the model's certainty about the presence of an object (e.g., drone) in a given region. In some instances, the confidence score can be affected by the quality and additional components of the image capturing system 102 regarding image quality. In some instances, the confidence score scan be related to the maximum likelihood estimator of each anchor determined for an image grid block. Additionally, the object classification can specify the class label of the detected object, for example, type of object (e.g., drone, airplane, bird, or any flying object), shape of object (e.g., square, fixed wing, propellers, number of blades), point of load, etc. Furthermore, the object tracking can specify the direction of object, altitude of object, speed of object.

In various implementation, the object tracking involves monitoring the movement and location of detected objects across multiple consecutive image frames. Based on the detection of object in the first image frame, the network continuously keeps processing the image frame for example two to three frame per second to track the detected object in each frame. In various implementations, the training model leverages its learned features and predictions from the previous image frames to track the detected objects over time. The continuous processing of image frames ensures consistent and real-time tracking, even when the objects appearance or position changes over the sequence of image frames. In various implementation, the object tracking provides the information such as direction of object, altitude of object, speed of object, predictions regarding flying path, etc.

In various implementations, during the object tracking process, the network can update the object tracking predictions in each frame based on the new information available. For example, adding a new object or a new class label, etc. By refining the object's location and class label in each frame, the architecture 300 provides a robust and accurate object tracking information. The model can be trained to dynamically adapt the variations in object appearance, motion, scale, lighting conditions, environmental conditions, etc. making it well-suited for the real world where the object can be constantly moving, and the location can be changing over time.

The loss 312 can be obtained as an output from the head 308 during the training process. The loss 312 can include three components, the class loss (312-1), the box loss (312-2), and the objectness loss (312-3), that can help to determine if there is an error in the GMM to determine whether the determinations are likely to be accurate. The class loss 312-1 measures the accuracy of class predictions for the detected object based on the maximum likelihood for each potential feature. The box loss 312-2 measures the accuracy of predicted bounding boxes coordinates compared to the ground truth boxes by comparing the amount of pixels in the image that are lost compared to the ground truth and background of the image. The objectness loss 312-1 evaluates the confidence of object predictions, indicating whether an object can be present in a given region. The loss 312 function combines these three components to calculate the overall loss for the model during the training process and, in some instances, can be used to determine how many Gaussians are needed for a particular object. Additional details of training data and processing of each frame is further explained in FIGS. 4-6.

FIG. 4 illustrates another perspective view of exemplary image frames (or image data) captured in various environment showing the presence of objects at numerous distances from the image capturing device 102 using multiple receptive fields. For example, the image frame 402 shows an object (or drone) captured by the image capturing device at about 800 meters distance, while image frame 404 shows the same object (or drone) captured by the image capturing device at 200 meters distance. Image frame 406 shows another object (or drone) captured by the image capturing device at over 1000 meters or more. The object captured in image frame 402 and image frame 404 can be a rotary drone and the object captured in image frame 406 can be a fixed wing drone. The image processing system 106 receives the image data 104 and detects the presence of object (e.g., drone) and various other features of the object using deep learning process that can include combination of GMM model and YOLO architecture.

The traditional techniques for detecting and tracking an object in an image frame can rely on a single receptive field under the GMM. However, using a single receptive field can lead to poor object detection performance that would otherwise fail to adequately capture features of the object when captured at further distances. Although a single receptive field can provide positive results for general object detection, when being applied to tiny object (or low amounts of pixels), the focus on the center of the object can be sub-optimal for object identification, which is used to prevent false positives. For instance, the use of a single receptive field could identify a flying object captured but may not be able to identify whether the object is a bird or a drone when compared to the ground truth, because the Gaussian distribution will focus on the center and reduce accuracy for the periphery. For example, by treating each object in an image frame as a single receptive field fails to capture the full pixel intensity and details of the object, such as the shape, size, and structure, and may focus solely on the centered body. When using the single receptive field, the GMM only captures patterns in the local region, but it may not clearly show the object's (or drone's) shape, size, or appearance.

Advantageously, the disclosed technique in this application can enhance object detection by using multiple receptive fields in the GMM. Each receptive field can be modeled using GMM to represent specific visual characteristics, such as texture, shape, size, color, and parts including any payload. The image frame can be divided into equal-sized grids (or tiles) and for each tile, so that different feature points can be selected as the local region (or receptive field) for modelling rather than only a single feature point, which is typically the body of the object (or drone).

By processing the object (or drone) captured at 800 meters using multiple receptive fields, rather than a single receptive field, the output can appear to include more structure. The multiple receptive fields can each select different features points, such as the wings, blades, or other structural details, for processing the image of the object, rather than a single localized region focusing on the body. As shown in FIG. 4(a), image frame 402 can be more accurately processed by using at least three receptive fields to illustrate gaussians not only with a central gaussian 402-1 on the body of the object, which may solely be used in a single receptive field, but also using periphery gaussians 402-2 for the rotors of the object. By processing each of these grids, which can focus on different features of the object (or drone) on the periphery of the object, the results can more clearly represent the complete structure of the object (or drone). In some instances, the multiple receptive fields can be adapted to different shapes, e.g., a fixed wing drone as compared to a rotary drone. In such instances, the weight is shifted to be less on the body or center of the object to more clearly depict the periphery of the object, and decrease the amount of false positives that are mismatched to the ground truths. Compared to anchor-based detectors that can require tuning hyperparameters to particular tasks (such as specific drones), the proposed disclosure reduces the impact on processing performance by providing flexibility for different tasks through multiple receptive fields each using anchor-free detection that can define a maximum likelihood estimation on multiple potential anchors (e.g. a rotor wing, a fixed wing, etc.) to determine a probability and/or confidence score in its identification. In some instances, use of multiple receptive fields can determine whether a drone has a payload. In some instances, use of multiple receptive fields can further include additional anchors to determine a particular type or model of drone.

FIGS. 4(b) and 4(c) illustrate the output of using multiple receptive fields in the GMM, showing clear representations of the drone, including its body, blades, and other structural details in image frame 404, and its head and tail in image frame 406. As shown in FIG. 4(b), the object captured at a closer distance has more detail, which more clearly defines the rotor drone's rotors, blades, wings, body, and other components, and although it may be able to be identified using a single receptive field because of the higher number of pixels factoring towards the center feature in the central gaussian 404-1, the use of multiple receptive fields can be helpful for more accurately determining the periphery features by processing the additional periphery gaussians 404-2. Images captured at closer distances include a larger number of pixels captured to influence the centralized feature, which can allow for increased clarity of the surrounding features and accuracy of the periphery. FIG. 4(c) would require at least three gaussians to distinguish the head of the object from the tail of the object, as the central gaussian 406-1 may not account for the disparate ends, that can otherwise be captured by the head gaussian 406-2 and the tail gaussian 406-3.

Therefore, proposed techniques provide reliable object detection, even for the tiniest objects at significant distances (e.g., 1000 or 5000 meters away from camera device), that can reduce false positives, and significantly improving the overall accuracy of the object detection and tracking process, while minimizing processing requirements. In some instances, the clearer representation of the object can determine the expected trajectory of the object, such as by analyzing the angle and/or direction of the object and in some instances, by tracking the object across multiple frames. The number of Gaussians utilized for the multiple receptive fields can be determined, such as when training through the YOLO loss 312 functions in the NN model 110. The training of the NN model 110 can, for instance, determine that at a particular distance, three receptive fields are needed, at another distance four receptive fields are needed, and under a certain distance only one receptive field is needed.

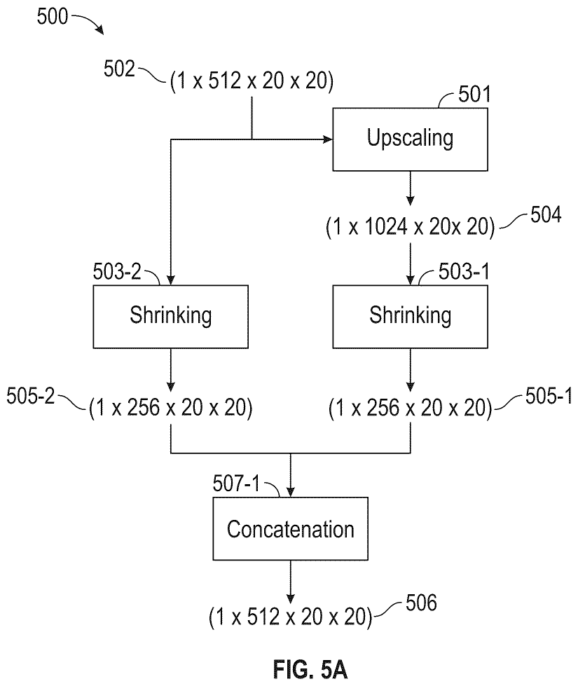

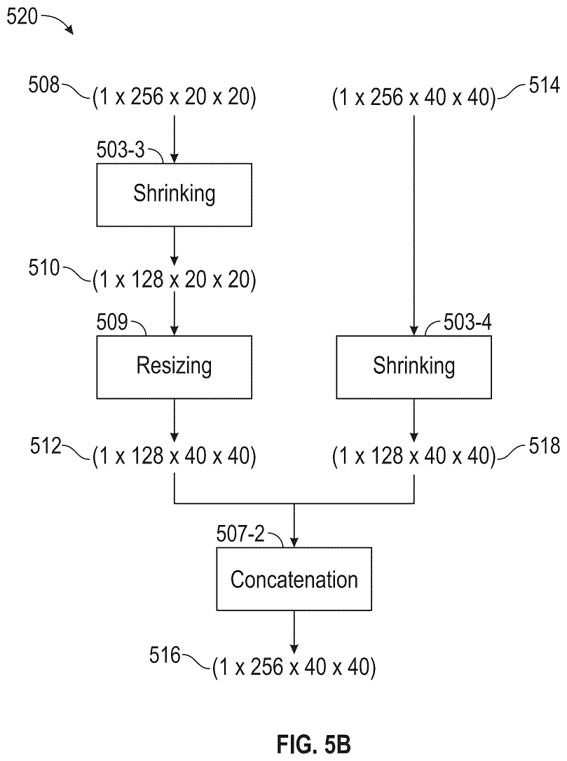

FIGS. 5(a) and 5(b) illustrate the flow chart of image processing according to some implementations. FIG. 5(a) shows the compound scaling process, while FIG. 5(b) illustrates the spatial upsampling process, such as within the example architecture 300. The compound scaling up depth and spatial upsampling processes can play a vital role in enhancing the model's object detection capabilities.

In this implementation, the proposed disclosure addresses various challenges faced in traditional approaches to detecting the tiniest objects in an image frame due to the loss of fine-grained features during down-sampling. To overcome this, the application incorporates an identity map to preserve low-level features in the feature maps. This can enable the network to capture subtle details and enhance the detection of tiny objects. Additionally, residual blocks can be employed to retain low-level features and improve overall detection performance.

The compound scaling up depth process, as depicted in FIG. 5(a), enhances the network's ability to capture and represent complex patterns in the input data by modifying the depth or number of channels in the feature maps. This empowers the network to handle various levels of complexity in the input data, leading to accurate and efficient object detection and localization. Furthermore, the multi-scale representation obtained through this process can significantly contribute to the high-performance object detection capabilities of the proposed framework, such as the YOLO architecture.

The process can begin with input tensor 502, which is illustrated with size 1×512×20×20, where “1” denotes the batch size, “512” denotes the number of channels, and “20×20” represents the spatial dimensions of the feature map. The network then can scale up the depth of the feature maps by upscaling 501 to increasing the number of channels from 512 to 1024, resulting in a tensor of a size 1×1024×20×20 (shown as tensor 504). In some implementations, the upsampling technique can increase the spatial resolution of the smallest detection head from two times to four times, for example, from 20×20 to 80×80, to help magnify the object after the network has shrunk it. This substantial increase in resolution allows the network to focus on finer details and achieve more accurate localization of tiny objects. The upsampled head can then be concatenated with the previous layer, facilitating the fusion of high-level and low-level features for robust object detection.

After the upscaling 501 process, the feature maps can be shrunk 503-1 back to 1×256×20×20 (shown as tensor 505-1) through various operations like convolutional layers and pooling, reducing the computational load while preserving essential information in the feature maps so that information relevant to each other can be more closer together. After the shrinking step, the tensor with 1×256×20×20 channels can be concatenated with another tensor of the same size, for example, 1×256×20×20 channels (shown as 505-2). This concatenation step (507-1) combines the information from both tensors, creating a multi-scale representation of the input data with a size of 1×512×20×20 (shown as output tensor 506). This enhancement significantly improves the object detection performance of the architecture by capturing and representing complex patterns and features in input data effectively.

The spatial up-sampling process, depicted in FIG. 5(b), illustrates how the proposed network elevates the spatial resolution of the feature maps, capturing finer details and enabling better localization of objects in the image.

The process begins with input tensor 508, illustrated with a size of 1×256×20×20, where “1” denotes the batch size, and “256: denotes the number of channels, and 20×20” denotes the spatial dimensions of the feature map. The network can first shrink 503-3 to reduce the tensor size to 1×128×20×20 (shown as tensor 510), effectively halving the spatial resolution along both dimensions. Subsequently, the feature maps can undergo resizing 512 to double their spatial resolution along both dimensions, resulting in a tensor size of 1×128×40×40 (shown as tensor 512). This spatial up-sampling step can augment the resolution, enabling the network to focus on finer details, which can be helpful for detecting and tracking smaller objects.

The up-sampled tensor 512, sized at 1×128×40×40, can be then concatenated 507-2 with another tensor 518 of same size, which contains information from previous layers. The concatenation 507-2 can form the output tensor 516, with a size of 1×256×40×40, which can allow the network to retain and leverage relevant details at a higher spatial resolution, thus facilitating more accurate object detection and tracking. Furthermore, the previous layer's output tensor 516 can be used an input tensor 514, with the size of 1×256×40×40, can be shrunk 503-4 to get tensor 518 so that the size matches that of tensor 512.

Furthermore, the proposed disclosure enhances the traditional upsampling process in the network from two times to four times. For instance, instead of the conventional upsampling by 2, the proposed network upsamples the 1×128×40×40 tensor by 4, resulting in a tensor size of 1×64×80×80. This substantial increase in the spatial resolution enhances the network's capability to detect and track even the smaller objects in the image more efficiently.

The sizes and values provided above are illustrative of an example and not intended to be limiting, the sizing and changes in sizing specified can be adjusted as needed.

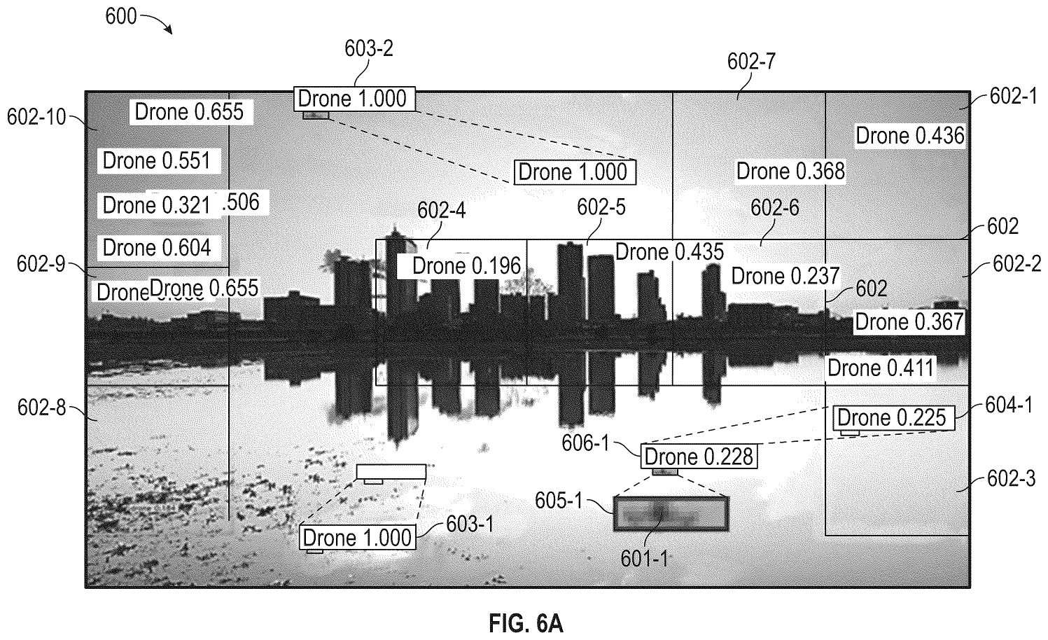

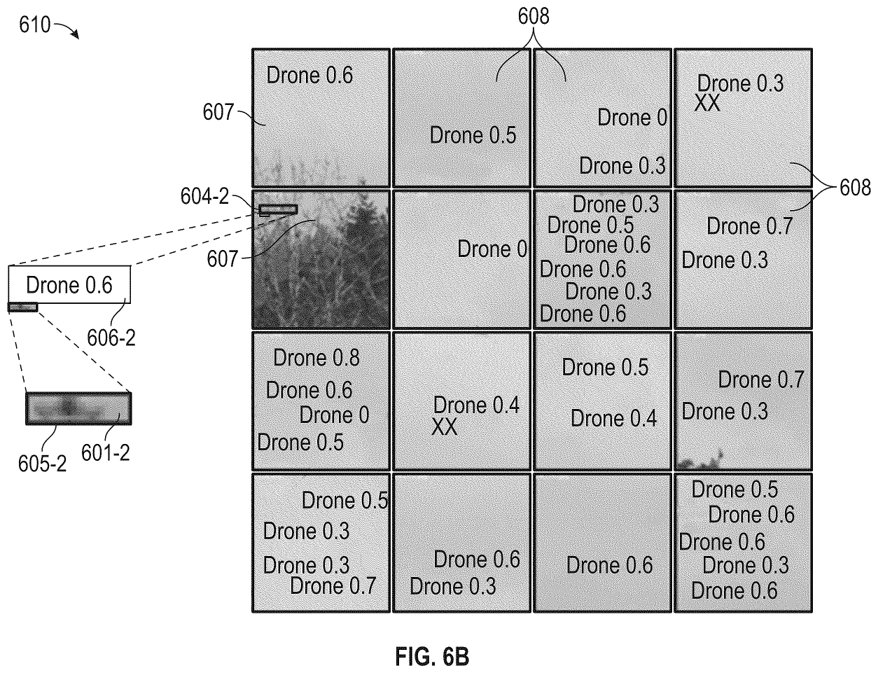

FIGS. 6(a) and 6(b) illustrate an output of image detecting system according to some implementations. In FIG. 6(a), image 600 can be a high resolution image captured during training. In some instances, the image 600 can be captured by a high-definition image capturing system 102, such as an 8K camera, and can have a resolution of 8000×8000. This resolution is intended to merely be an example and can be any resolution, such as 3000×3000, 4000×4000, etc. Additionally, the image 600 can be captured based on an aggregation of more than image capturing system 102. As described above, a detected object 601, such as a drone, sought to be detected by the system could a small portion of the total pixels in the image 600 and can be dependent on the distance of the detected object 601 from the image capturing system 102. The image 600 displays a grid 602 of 3×6, with objects detected in each grid (e.g., 602-1, 602-2, . . . 602-10). The image 600 can be divided into multiple grids, and each grid undergoes processing in the image processing system 106. In some instances, each grid can be processed sequentially and, in some instances, each grid can be concurrently processed. By reducing the image 600 into grids, the ratio of the detected object 601 to the amount of background is reduced by the amount of grids, e.g., if the image were 1800×1800, each grid would be 100×100 in FIG. 6(a). After each grid is analyzed, it can be recombined to form the full image 600. As shown in FIG. 6(a), grid lines may only be displayed for grids 602 that include a detected object 601, aside from ground truths 603. In contrast, FIG. 6(b) displays grid line for all grids 602, and in some instances, as shown, but include images for only particular grids 607 but not for other grids 608. In such instances, a particular detected object 601-2 may be of interest and the grids displayed may be those related to the position or expected position of the detected object 601-2.

The input image can be subjected to the above-described techniques of GMM, YOLO architecture within the network model. The network provides object detection results for each grid in every image frame, presenting bounding boxes (e.g., 604-1) around the detected objects (e.g., 601-1) and displaying a confidence score 606-1 for each detected object. For illustrative purposes, a magnified view has been included for detected object, which can include the detected object 601-1, a bounding box for the detected object 605-1, and the confidence score 606-1 alongside an “object” tag to help indicate the location of the 601-1, which is much smaller as shown. In some instances, as shown, the confidence score 606 can be from 0.000 to 1.000, with a higher number indicating a higher likelihood of a detected object. In some instances, the image 600 may not include objects that have a confidence score 606 below a threshold value, for example 0.050. In some instances the bounding boxes 604 can be depicted in a color, such as red, to help identify the associated detected object 601. Additionally, the image 600 can include ground truths 603 that have been annotated by the user, to help provide training comparisons and/or from user annotation due to a missed object. As shown, ground truths 603 has a confidence score of 1.000 to indicate that the object is at that position. Ground truths 603 may been depicted similarly to a detected object 601 but may be displayed in a different format to easily differentiate, such as a blue bounding box 604.

As mentioned above, FIG. 6(a) is illustrative of an output of image detecting system during the training process, as indicated by the representations of ground truth 603. Therefore, the confidence score 603 can be representative of loss functions calculated during the training process, such as those compared to the ground truths 603. FIG. 6(b) is an illustrative example of an output of image 610 detecting system during real-time use without ground truths. In such instances, the confidence scores 603 may not be related to loss functions, which may not be calculated during non-training, but can be indicative of other factors mentioned above, such as image quality and comparisons to the training data. Additionally, the output of image detecting system during real-time use can appear more similarly to image 600 depicted in FIG. 6(a) without the ground truths 603 and where the confidence scores are as described for FIG. 6(b), and can thus, illustrate the entirety of the image 600 and relevant grids during real-time use. In some instances, the output of image detecting system can be a video with the classification and tracking grids 602 and detected objects 601 overlayed on each associated frames of the video.

In some implementations, the proposed object detection and tracking process leverages the theoretical effective receptive field (ERF) concept within the YOLO architecture. The ERF process helps in understanding the region of influence around each point in the convolutional neural network, enabling the identification of key regions contributing to object detection. By optimizing the object detection and tracking process with ERF insights, the disclosure utilizes the location of each feature point as the mean vector of a standard mixture 2-D Gaussian distribution, better approximating ERF radius (Ern). This approximation effectively captures essential visual features of the objects in each grid of each image. The square of the approximate radius serves as the covariance, guiding the spread of 2-D Gaussian distribution for a square like convolution kernel.

For instance, the input image undergoes processing using the YOLO architecture, which incorporates the theoretical ERF concept. As per the theoretical ERF concept, The ERF of the n-th layer in a standard CNN can be defined by the formula

trn=trₙ₋₁+(kₙ−1)πsᵢ i in (1,n−1),

where trn denotes the ERF of each point on the n-th convolution layer, kn and sn denotes the kernel size and stride of the convolution operation on the n-th layer. To capture essential visual features of objects, the proposed disclosure approximates the ERF radius (Ern) with half the radius of ERF, and the location of each feature point (xn, yn) can be used as the mean vector of a mixture of 2-D Gaussian distribution. The square of Ern serves as the covariance, guiding the spread of the 2-D Gaussian distribution for a square-like convolution kernel. The range of ERF can be effectively modeled as a 2-D Gaussian distribution, optimizing object detection and localization in real-world scenarios.

By effectively modeling the range of ERF as a 2-D Gaussian distribution, the proposed techniques enhance the sensitivity of the neural network to critical object features, resulting improved object detection and tracking accuracy. Therefore, the incorporation of the theoretical ERF in the proposed YOLO architecture plays a crucial role in efficiently identifying and localizing objects in real-world scenarios.

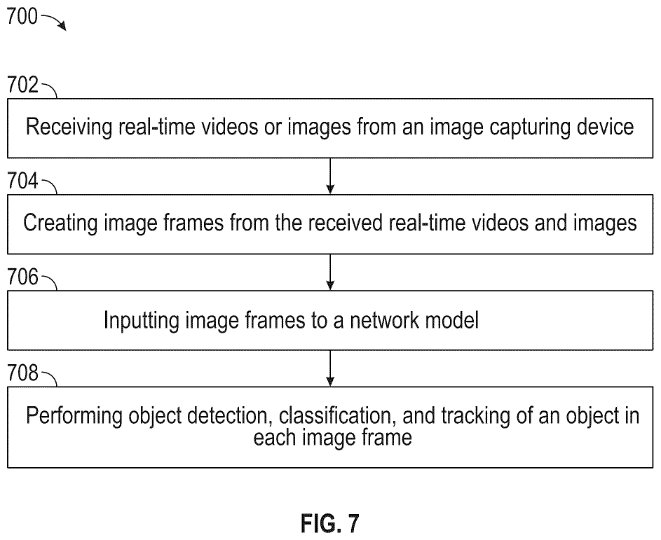

FIG. 7 illustrates a method for performing target object detection, classification, and tracking according to one or more aspects. The method 700 can be implemented by the image processing system 106. The method 700 includes receiving real-time videos or images from an image capturing device, as shown in 702. The method 700 further includes creating image frames from the received real-time videos and images, as shown in 704. The method 700 further includes inputting image frames to an image analysis system, as shown in 706. In various aspects, the image analysis system (or sometimes referred to as an image analytic system) includes image processing system and object detection and tracking system that incorporates a combination of GMM model and YOLO architecture to detect an object, classify an object and track an object in an image frame. The image analytic system may include one or more processors or electronic processing systems. In various implementation, the image analytic system includes a Convolutional training mode which can be trained on a diverse dataset comprising 4000 or more images having high resolution of about 3K×3K, and more than 120,000 positive training samples representing wide range of objects and scenarios, such as but not limited to different types of drones, drones at different distances, drones in different positions, drones in different lighting, etc. The method further includes performing object detection, classification, and tracking of an object in each image frame by the image analytic system, as shown in 708.

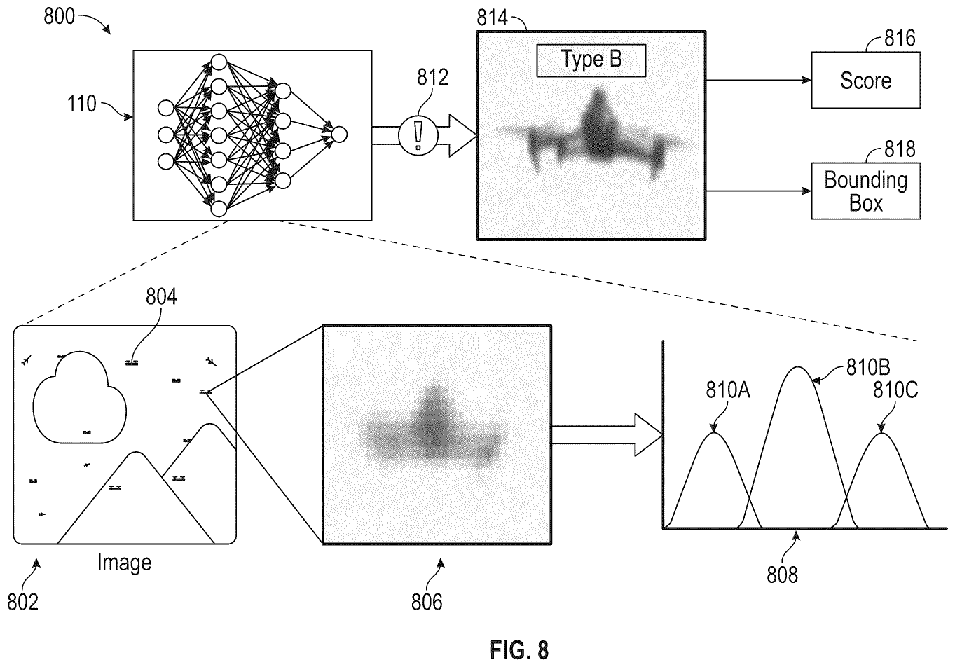

FIG. 8 illustrates a computing environment 800 in which a neural network detects and classifies a target object imaged according to one or more aspects. The computing environment 800 may be implemented via one or more processors and memory of the image processing system 106 discussed with respect to FIG. 1. More particularly, the NN model 110 implemented in the computing environment 800 detects and classifies a target object based on image data 104 provided by the image capturing system 102.

The NN model 110 receives video data that includes an image 802 that includes one or more target objects 804 comprising a small number of pixels relative to the overall number of pixels of the image 802. For instance, a target object in the image 802 may comprise 50 or fewer pixels in some implementations. The NN model 110 can be trained to process the image 802 to detect and classify target objects represented in the image 802. For instance, the NN model 110 may divide the image 802 into a plurality of tiles and downsample each of the tiles into blocks via the YOLO backbone 302 described with respect to FIG. 3. The NN model 110 then performs convolution operations involving the downsampled blocks to detect features in the image tiles via the YOLO neck 304 also discussed with respect to FIG. 3.

The NN model 110 can be trained to detect or map features in the image and determine whether the features correspond to target objects. More specifically, the NN model 110 can be trained to, for an individual feature 806 in the image 804, a GMM 808 comprising a plurality of gaussians 810. The gaussians 810 may correspond to respective segments comprising a sets of pixels of the feature 806 in some implementations. For instance, a first gaussian 810A may correspond to a left portion of the feature 806, a second gaussian 810B may correspond to a middle portion of the feature 806, and a third gaussian 810C may correspond to a right portion of the feature 806. The number of gaussians 810 that the NN model 110 generates for the GMM 808 may be a parameter adjusted or selected to train the NN model 110.

Using the GMM 808 generated, the NN model 110 can be trained to detect whether the feature 806 corresponds to a target object, such as a UAV. As a result of determining that the GMM 808 corresponds to the GMM of a target object, the NN model 110 registers a positive detection 812 for the feature 806. The NN model 110, in some aspects, can be trained to identify or classify a type 814 of the target object based on the GMM 808. In some aspects, the NN model 110 can be trained to generate a confidence score 816 indicating a level of confidence that the GMM 808 corresponds to a GMM of a target object or a level of confidence that the GMM 808 corresponds to a GMM of a particular type of target object. In some aspects, the NN model 110 can be trained to identify a location of the target object within the image 804 or within a tile thereof and to generate a bounding box 818 corresponding to a size of the target object within the image or tile thereof. In some aspects, the NN model 110 can be trained or configured to output the confidence score 816 and/or the bounding box 818 in real-time in video data received from the image capturing system 102.

### Other Variations

Features, materials, characteristics, or groups described in conjunction with a particular aspect, aspect, or example are to be understood to be applicable to any other aspect, aspect or example described herein unless incompatible therewith. All the features disclosed in this specification (including any accompanying claims, abstract and drawings), and/or all the steps of any method or process so disclosed, may be combined in any combination, except combinations where at least some of such features and/or steps are mutually exclusive. The protection is not restricted to the details of any foregoing aspects. The protection extends to any novel one, or any novel combination, of the features disclosed in this specification (including any accompanying claims, abstract and drawings), or to any novel one, or any novel combination, of the steps of any method or process so disclosed.

While certain aspects have been described, these aspects have been presented by way of example only and are not intended to limit the scope of protection. Indeed, the novel methods and systems described herein may be embodied in a variety of other forms. Furthermore, various omissions, substitutions, and changes in the form of the methods and systems described herein may be made. Those skilled in the art will appreciate that in some aspects, the actual steps taken in the processes disclosed and/or illustrated may differ from those shown in the figures. Depending on the aspect, certain of the steps described above may be removed, others may be added. For example, the actual steps and/or order of steps taken in the disclosed processes may differ from those described and/or shown in the figure. Depending on the aspect, certain of the steps described above may be removed, others may be added. For instance, the various components illustrated in the figures and/or described may be implemented as software and/or firmware on a processor, controller, ASIC, FPGA, and/or dedicated hardware. Furthermore, the features and attributes of the specific aspects disclosed above may be combined in different ways to form additional aspects, all of which fall within the scope of the present disclosure.

In some cases, there is provided a non-transitory computer readable medium storing instructions, which when executed by at least one computing or processing device, cause performing any of the methods as generally shown or described herein and equivalents thereof.

Any of the memory components described herein can include volatile memory, such random-access memory (RAM), dynamic random access memory (DRAM), synchronous dynamic random access memory (SDRAM), double data rate (DDR) memory, static random access memory (SRAM), other volatile memory, or any combination thereof. Any of the memory components described herein can include non-volatile memory, such as magnetic storage, flash integrated circuits, read only memory (ROM), Chalcogenide random access memory (C-RAM), Phase Change Memory (PC-RAM or PRAM), Programmable Metallization Cell RAM (PMC-RAM or PMCm), Ovonic Unified Memory (OUM), Resistance RAM (RRAM), NAND memory (e.g., single-level cell (SLC) memory, multi-level cell (MLC) memory, or any combination thereof), NOR memory, EEPROM, Ferroelectric Memory (FeRAM), Magnetoresistive RAM (MRAM), other discrete NVM (non-volatile memory) chips, or any combination thereof.

Any user interface screens illustrated and described herein can include additional and/or alternative components. These components can include menus, lists, buttons, text boxes, labels, radio buttons, scroll bars, sliders, checkboxes, combo boxes, status bars, dialog boxes, windows, and the like. User interface screens can include additional and/or alternative information. Components can be arranged, grouped, displayed in any suitable order.

Conditional language used herein, such as, among others, “can,” “could,” “might,” “may,” “e.g.,” and the like, unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more aspects or that one or more aspects necessarily include logic for deciding, with or without other input or prompting, whether these features, elements and/or steps are included or are to be performed in any particular aspect. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain aspects require at least one of X, at least one of Y, or at least one of Z to each be present.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, or within less than 0.01% of the stated amount.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations.

The foregoing description, for purposes of explanation, used specific nomenclature to provide a thorough understanding of the disclosure. However, it will be apparent to one skilled in the art that specific details are not required in order to practice the disclosed aspects. Thus, the foregoing descriptions of specific aspects are presented for purposes of illustration and description. They are not intended to be exhaustive or to limit the disclosure to the precise forms disclosed; obviously, many modifications and variations are possible in view of the above teachings. The aspects were chosen and described in order to best explain the principles of the disclosure and its practical applications, they thereby enable others skilled in the art to best utilize the disclosure and various aspects with various modifications as are suited to the particular use contemplated. It is intended that the claims as presented herein or as presented in the future and their equivalents define the scope of the protection.

1. An object detection system, comprising:
an image capture system configured to obtain image data comprising at least one image frame; and
a memory storing instructions that, when executed by one or more processors, cause the one or more processors to execute a network model configured to implement a Gaussian Mixture model (GMM) to detect one or more targeted objects from a plurality of potential objects in the at least one image frame, the one or more targeted objects comprising less than 1/100^{th} pixels of a total number of pixels in the at least one image frame.

2. The object detection system of claim 1, wherein the GMM is configured to generate a Gaussian Receptive Fields (GRFs) to dynamically adapt to diverse shapes and sizes of the one or more targeted objects in the at least one image frame.

3. The object detection system of claim 2, wherein execution of the instructions causes the one or more processors to divide the at least one image frame into a plurality of image tiles, and wherein the network model is configured to apply one or more of the GRFs to each of the plurality of image tiles independently to capture local details and variations in the one or more targeted objects in the at least one image frame.

4. The object detection system of claim 1, wherein execution of the instructions causes the one or more processors to divide the at least one image frame into a plurality of image tiles, to detect the one or more targeted objects in each of the plurality of image tiles, the one or more targeted objects comprising less than a factor of each of the image tiles, the factor being 1/100^{th} multiplied by a number of image tiles of the plurality of tiles, and to aggregate the plurality of images tiles for the detection of the one or more targeted objects in the at least one image frame.

5. The object detection system of claim 4, wherein execution of the instruction cause the one or more processors to alert a user responsive to the one or more targeted objects being detected in an image tile of the plurality of image tiles.

6. The object detection system of claim 1, wherein the network model is configured to determine an optimal number of Gaussian components for the GMM for accurate identification of the one or more targeted objects in the at least one image frame, the Gaussian components are associated with at least one structure in the one or more targeted objects.

7. The object detection system of claim 6, wherein execution of the instructions causes the one or more processors to identify the one or more targeted objects based on comparing each the Gaussian components to a plurality of anchors, the plurality of anchors comprising at least one structure in the plurality of potential objects.

8. The object detection system of claim 7, wherein execution of the instructions causes the one or more processors to identify the one or more targeted objects based on a maximum likelihood estimation for each of the plurality of anchors.

9. The object detection system of claim 6, wherein the network model comprises a neural network model configured to process the at least one image frame to determine the optimal number of the Gaussian components for each of the one or more targeted objects in the at least one image frame, the optimal number of the Gaussian components comprising a minimum number of the Gaussian components.

10. The object detection system of claim 1, wherein the network model comprises a modified You Only Look Once (YOLO) architecture, and wherein the modified YOLO architecture comprises a feature pyramid network configured to upsample the image data by at least four times to capture fine-grained details of the one or more targeted objects in the at least one image frame.

11. The object detection system of claim 10, wherein the modified YOLO architecture is configured to perform compound scaling of the image data.

12. The object detection system of claim 1, wherein execution of the instructions causes the one or more processors to determine a confidence score for the one or more targeted objects.

13. The object detection system of claim 12, further comprising a display configured to display the at least one image frame, the one or more targeted objects, and features corresponding to each of the one or more targeted objects,
wherein execution of the instructions causes the one or more processors to determine the features comprising a bounding box surrounding the one or more targeted objects and the confidence score for the one or more targeted objects.

14. The object detection system of claim 13, wherein the one or more targeted objects change at least one of an appearance or location from a first image frame in the at least one image frame to a second image frame in the at least one image frame, and
wherein the display is configured to display the at least one image frame, the one or more targeted objects in each respective image frame, and the features corresponding to each of the one or more targeted objects in a sequential order, the at least one frame comprising the first image frame and the second image frame.

15. The object detection system of claim 13, wherein the one or more processors are further caused to detect the one or more targeted objects and the corresponding features in 500 milliseconds or less.

16. The object detection system of claim 1, wherein the plurality of potential objects comprises animals, unmanned vehicles, and manned vehicles, and wherein the one or more targeted objects comprise the unmanned vehicles.

17. The object detection system of claim 1, wherein each of the one or more targeted objects occupy less than 1/500^{th} pixels than the total number of pixels in the at least one image frame.

18. The object detection system of claim 1, wherein the network model is configured to determine at least one loss function associated with the detection of the one or more targeted objects.

19. The object detection system of claim 18, wherein execution of the instructions causes the one or more processors to determine a confidence score for the detection of the one or more targeted objects, the confidence score being associated with at least one of the at least one loss function or an image quality associated with the image data, and wherein execution of the instructions causes the one or processors to train the network model based on the at least one loss function.

20. The object detection system of claim 1, wherein execution of the instructions causes the one or more processors to train the network model based on training data comprising the plurality of potential objects in various scenarios, and wherein the various scenarios comprises at least one of the plurality of potential objects in at least one of a different orientation or distance.

21. The object detection system of claim 1, wherein execution of the instructions causes the one or more processors to:
detect that the one or more targeted objects is carrying a payload, and
alert a user on a location of the one or more targeted objects carrying the payload.

22. A method for detecting an object in an image frame, the method comprising, by one or more processors:
receiving real-time image data from an image capturing device, the real-time image data comprising at least one image frame;
inputting the at least one image frame into a network model configured to generate a Gaussian mixture model (GMM) to detect one or more targeted objects in the at least one image frame; and
by the network model, detecting the one or more targeted objects from a plurality of potential objects in the at least one image frame, the one or more targeted objects comprising less than 1/100^{th} pixels of a total number of pixels in the at least one image frame.

23. A method for training an object detection system, the method comprising, by one or more processors:
inputting training data comprising a plurality of potential objects in various scenarios into a network model, the plurality of potential objects comprising one or more targeted objects,
training the network model based on the training data;
inputting an image frame captured by an image-capturing device into the network model, the network model configured to generate a Gaussian mixture model (GMM) configured to detect the one or more targeted objects in the image frame, the one or more potential objects comprising less than 1/100^{th} pixels of a total number of pixels in the image frame;
processing at least a portion of the image frame including at least one of the one or more targeted objects with the network model to detect the one or more objects;
inputting, via a user interface, a ground truth for any of the one or more targeted objects not detected by the network model;
determining at least one loss function associated with each of the one or more targeted objects detected; and
re-training the network model based on the at least one loss function.
